(19) United States
(12) Patent Application Publication
(10) Pub. No.: US 2013/0049345 A1
(43) Pub. Date: Feb. 28, 2013

(54) PEN OR PENCIL HOLDER FOR NOTEBOOK, PLANNER OR BINDER COVER PANEL

(71) Applicant: David Imbernino, Santa Monica, CA (US)

(72) Inventor: David Imbernino, Santa Monica, CA (US)

(73) Assignee: CLEMENTINE PAPER, INC., Santa Monica, CA (US)

(21) Appl. No.: 13/599,845

(22) Filed: Aug. 30, 2012

Related U.S. Application Data
(60) Provisional application No. 61/529,182, filed on Aug. 30, 2011.

(51) Int. Cl. B42D 3/18

(52) U.S. Cl. 281/31

(57) ABSTRACT

An improved front or back cover panel of a bound or loose-leaf notebook, book, journal, planner, calendar, ring binder, or the like, is provided with a notch, groove or slot on the outside surface of the cover panel, with a strap permanently or removably affixed to the outside surface of the front or back cover panel and extending across the notch, groove or slot, to removably receive and retain a pen, pencil, stylus or other type of writing instrument in the notch, groove or slot.

### CROSS-REFERENCES TO RELATED APPLICATIONS

This application is based upon and claims priority from U.S. Provisional Application No. 61/529,182, filed Aug. 30, 2011, incorporated by reference in its entirety.

### BACKGROUND OF THE INVENTION

The present invention generally relates to bound or loose-leaf notebooks, books, journals, planners, calendars, ring binders and the like, and more particularly relates to a receptacle formed in an outside surface of a front or back cover panel of a bound or loose-leaf notebook, book, journal, planner, calendar, ring binder, or a similar type of cover panel, with a strap extending across the receptacle for removably receiving and retaining a pen, pencil, stylus or other type of writing instrument.

A conventional binder is known that includes an interior hold down page including one or more article holders for holding articles such as pens or pencils. In one form, a pen or pencil holder is formed by a loop or plurality of loops formed by a strap anchored to the hold down page. Another conventional protective enclosure for touch screen device is known that includes a shell for enclosing an electronic device, and a portion of the shell can be molded to form an outside receptacle for removably retaining a stylus.

Another known conventional type of pen or pencil holder for a planner includes an outer strap attached to an outer edge of a cover of the planner that can be snapped to an outer adjacent edge of the opposing cover, allowing a pen or pencil to be placed on the outside of the planner between the strap and pages of the planner. A similar type of pen or pencil holder for a planner is known that can be formed by tightly wrapping a strap around the outer edges of the entire planner so that a pen or pencil may be loosely held on the outside of the planner between the strap and pages or outside surface of the planner. However, a pen or pencil retained by such conventional straps on the outside of a such a planner can easily twist or yaw underneath the strap to such an extent that the pen or pencil can readily become dislodged.

It would be desirable to provide an outside surface of a front or back cover panel of a bound or loose-leaf notebook, book, journal, planner, calendar, ring binder, or a similar type of panel, with a notch, groove or slot formed to have a sufficient width, length and depth for removably receiving a pen, pencil, stylus or other type of writing instrument, to be removably retained within the notch, groove or slot by a strap permanently or removably affixed to the outside surface of the front or back cover panel and extending across the notch, groove or slot, to restrain a pen, pencil, stylus or other type of writing instrument placed in the notch, groove or slot from twisting or other similar yaw movement beneath the strap. The present invention meets these and other needs.

### SUMMARY OF THE INVENTION

Briefly and in general terms, the present invention provides for an improved front or back cover panel of a bound or loose-leaf notebook, book, journal, planner, calendar, ring binder, or a similar type of panel, with a notch, groove or slot, with a strap permanently or removably affixed to the outside surface of the front or back cover panel so as to extend across the notch, groove or slot, such that the combination of the notch, groove or slot and strap is configured to removably receive and retain a pen, pencil, stylus or other type of writing instrument placed in the notch, groove or slot on the outside surface of the cover panel. The adjacent opposing side edges or shoulders of the notch, groove or slot are preferably spaced apart an appropriate distance so that a pen, pencil, stylus or other type of writing instrument placed in the notch, groove or slot is restrained from twisting or other similar yaw movement beneath the strap, and the strap is preferably formed of an elastic material to allow the combination of the strap extending over the notch, groove or slot to accept various sizes and shapes of pens, pencils, styluses or other types of writing instruments.

Accordingly, the present invention provides for a cover panel for a bound or loose-leaf book of collected pages. The cover panel includes a panel having a strap affixed to the outside surface of the panel, and the panel advantageously has an outside surface with an elongated receptacle formed therein. The receptacle preferably has a sufficient width, length and depth for removably receiving a writing instrument, and the strap affixed to the outside surface of the panel is configured to extend across the receptacle, such that the strap and the receptacle are configured to removably receive and removably retain a writing instrument placed in the receptacle under the strap.

In a presently preferred aspect, the receptacle includes adjacent opposing side shoulders spaced apart a distance such that the writing instrument placed in the receptacle will be restrained from twisting beneath the strap. In one presently preferred aspect, the shoulders of the receptacle are formed by layered sheets of material on the panel. In another presently preferred aspect, the elongated receptacle and the shoulders are formed integrally in the panel by injection molding.

In another presently preferred aspect, the strap may be permanently or removably affixed to the outside surface of the panel. In another presently preferred aspect, the strap is affixed to the outside surface of the panel by fasteners. In another presently preferred aspect, the strap is formed of an elastic material.

These and other features and advantages of the present invention will become more apparent from the following detailed description of the preferred embodiment in conjunction with the accompanying drawings, which illustrate, by way of example, the construction and operation of the invention.

### BRIEF DESCRIPTION OF THE DRAWINGS

FIG. 1 is a perspective view of a front or back cover panel of a bound or loose-leaf notebook, book, journal, planner, calendar, ring binder, or the like, according to the invention.

FIG. 2 is a top plan view of the front or back cover panel of FIG. 1.

FIG. 3 is a perspective view of the front or back cover panel of FIG. 1, shown retaining a pencil.

FIG. 4 is a top plan view of the front or back cover panel of FIG. 1, shown retaining a pencil.

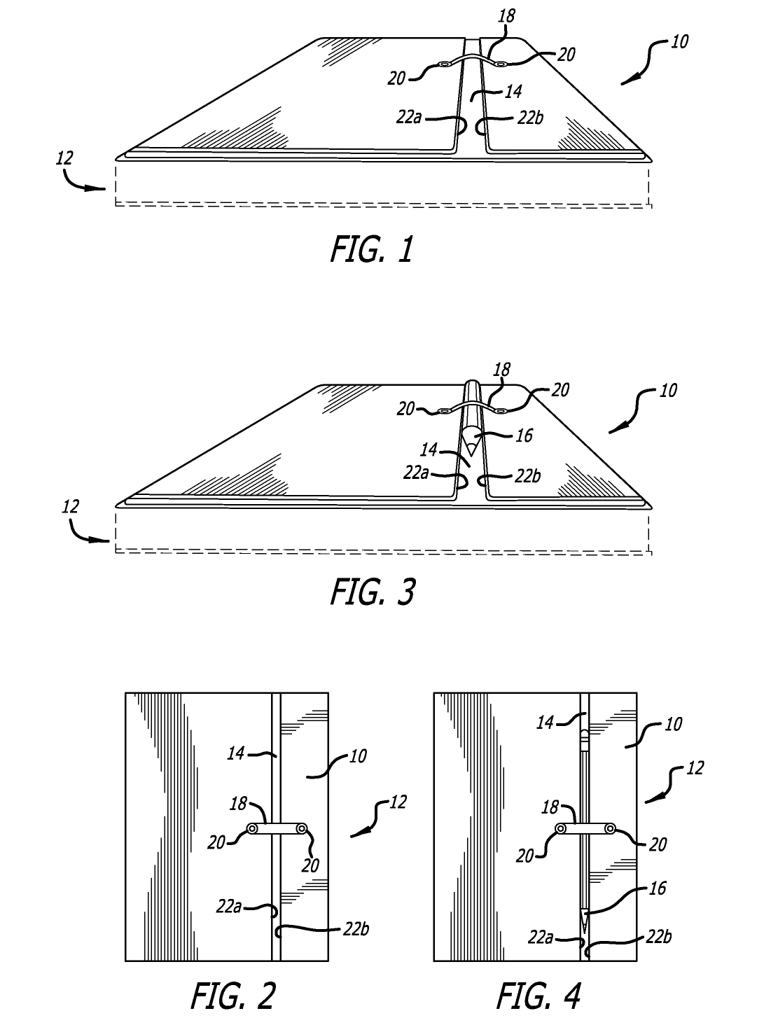

### DETAILED DESCRIPTION OF THE PREFERRED EMBODIMENTS

Referring to the drawings, which are provided by way of example for purposes of illustration, and not by way of limitation, the present invention provides for a front or back cover panel 10 of a book of collected pages 12, such as a bound or loose-leaf notebook, book, journal, planner, calendar, or ring binder of collected pages, or the like, for example. The panel includes a recess or receptacle 14, such as a notch, groove or slot, for example, that is formed on the outside surface of the panel to have a sufficient width, length and depth to form a receptacle for removably receiving a pen, pencil, stylus or other type of writing instrument 16, as shown in FIGS. 3 and 4. A strap 18 is permanently or removably affixed to the outside surface of the front or back cover panel by fasteners 20, such as rivets or snaps, or other similar fasteners, for example, so as to extend across the notch, groove or slot sufficiently tightly to removably retain a pen, pencil, stylus or other type of writing instrument placed in the notch, groove or slot. The adjacent opposing side edges or shoulders 22a, 22b of the notch, groove or slot are preferably spaced apart an appropriate distance such that a pen, pencil, stylus or other type of writing instrument placed in the notch, groove or slot will be restrained from twisting or other similar yaw movement beneath the strap, as is illustrated in FIGS. 3 and 4. The strap is preferably formed of an elastic material to allow the combination of the strap extending over the notch, groove or slot to accept various sizes and shapes of pens, pencils, styluses or other types of writing instruments.

In a presently preferred aspect, the notch, groove or slot created on the cover of a bound or loose-leaf notebook, book, journal, planner, calendar, ring binder, or the like, is approximately 5/16″ wide and a minimum of about ⅛″ deep. This notch, groove or slot holds a pen or pencil in place when used in conjunction with a strap, such as an elastic strap, for example, that is affixed to the cover. The notch, groove or slot can be created by layering sheets of paperboard or polypropylene to form the extent of the cover panel on either side of the side edges or shoulders of the notch, groove or slot. Alternatively, the notch, groove or slot can be created by injection molding one or more of the front or back cover panels to have the notch, groove or slot integrally formed in the outside surface of the one or more of the front or back cover panels.

It will be apparent from the foregoing that while particular forms of the invention have been illustrated and described, various modifications can be made without departing from the spirit and scope of the invention.

I claim:

1. A cover panel for a bound or loose-leaf book of collected pages, comprising:
a panel having an outside surface with an elongated receptacle formed therein, said receptacle having a sufficient width, length and depth to form a receptacle for removably receiving a writing instrument; and
a strap affixed to the outside surface of said panel and configured to extend across said receptacle, such that said strap and said receptacle are configured to removably receive and removably retain the writing instrument.

2. The cover panel of claim 1, wherein said receptacle includes adjacent opposing side shoulders spaced apart a distance such that the writing instrument placed in the receptacle will be restrained from twisting beneath the strap.

3. The cover panel of claim 3, wherein said shoulders of said receptacle are formed by layered sheets of material on said panel.

4. The cover panel of claim 3, wherein said elongated receptacle and said shoulders are formed integrally in said panel by injection molding.

5. The cover panel of claim 1, wherein said strap is permanently affixed to the outside surface of said panel.

6. The cover panel of claim 1, wherein said strap is removably affixed to the outside surface of said panel.

7. The cover panel of claim 1, wherein said strap is affixed to affixed to the outside surface of said panel by fasteners.

8. The cover panel of claim 1, wherein said strap is formed of an elastic material.

9. A cover panel for a bound or loose-leaf book of collected pages, comprising:
a panel having an outside surface with an elongated receptacle formed therein, said receptacle having a sufficient width, length and depth to form a receptacle for removably receiving a writing instrument; and
a strap affixed to the outside surface of said panel and configured to extend across said receptacle, such that said strap and said receptacle are configured to removably receive and removably retain the writing instrument, wherein said receptacle includes adjacent opposing side shoulders spaced apart a distance such that the writing instrument placed in the receptacle will be restrained from twisting beneath the strap.

10. The cover panel of claim 9, wherein said shoulders of said receptacle are formed by layered sheets of material on said panel.

11. The cover panel of claim 9, wherein said elongated receptacle and said shoulders are formed integrally in said panel by injection molding.

12. The cover panel of claim 9, wherein said strap is permanently affixed to the outside surface of said panel.

13. The cover panel of claim 9, wherein said strap is removably affixed to the outside surface of said panel.

14. The cover panel of claim 9, wherein said strap is affixed to affixed to the outside surface of said panel by fasteners.

15. The cover panel of claim 9, wherein said strap is formed of an elastic material.
